(19) United States
(12) Patent Application Publication
(10) Pub. No.: US 2022/0121815 A1
(43) Pub. Date: Apr. 21, 2022

(54) DEVICE AND METHOD FOR FILLING A KNOWLEDGE GRAPH, TRAINING METHOD THEREFOR

(71) Applicant: Robert Bosch GmbH, Stuttgart (DE)

(72) Inventors: Stefan Gruenewald, Stuttgart (DE); Annemarie Friedrich, Weil Der Stadt (DE)

(21) Appl. No.: 17/450,489

(22) Filed: Oct. 11, 2021

(30) Foreign Application Priority Data
Oct. 19, 2020 (DE) 10 2020 213 176.7

(51) Int. Cl. G06F 40/211; G06N 5/02; G06F 40/284

(52) U.S. Cl. CPC G06F 40/211; G06F 40/284; G06N 5/02

(57) ABSTRACT

A device and computer-implemented method for filling a knowledge graph. The knowledge graph is filled with nodes for the tokens from a set of tokens. A classification for a pair of tokens from the set of tokens is determined, a first token of the pair being assigned to a first node in the knowledge graph, a second token of the pair being assigned to a second node in the knowledge graph. A weight for an edge between the first node and the second node is determined as a function of the classification. A graph or a spanning tree is determined for the edge as a function of the first node, the second node, and the weight. The knowledge graph is filled with a relation for the pair if the graph or the spanning tree includes the edge, and the knowledge graph otherwise not being filled with the relation.

### FIELD

The present invention is directed to a device and to a method for filling a knowledge graph, in particular, using a syntactic parser. The present invention also relates to a training method therefor.

### BACKGROUND INFORMATION

Syntactic parsers for parsing text are described, for example, in the following publications.

Dan Kondratyuk and Milan Straka. 2019. “75 languages, 1 model: Parsing universal dependencies universally.” In Proceedings of the 2019 Conference on Empirical Methods in Natural Language Processing and the 9th International Joint Conference on Natural Language Processing (EMNLP/IJCNLP), pages 2779-2795, Hong Kong, China. Association for Computational Linguistics.

Timothy Dozat and Christopher D. Manning. 2018. “Simpler but more accurate semantic dependency parsing.” In Proceedings of the 56th Annual Meeting of the Association for Computational Linguistics (Volume 2: Short Papers), pages 484-490, Melbourne, Australia. Association for Computational Linguistics.

Stefan Grünewald and Annemarie Friedrich. 2020. “RobertNLP at the IWPT 2020 Shared Task: Surprisingly Simple Enhanced UD Parsing for English.” In Proceedings of the 16th International Conference on Parsing Technologies and the IWPT 2020 Shared Task on Parsing into Enhanced Universal Dependencies, pages 245-252, Online. Association for Computational Linguistics.

### SUMMARY

A significant improvement over the related art may be achieved with the computer-implemented method and the device according to an example embodiment of the present invention.

In accordance with an example embodiment of the present invention, the computer-implemented method provides that for filling a knowledge graph, the knowledge graph is filled with nodes for the tokens from a set of tokens, a classification for a pair of tokens from the set of tokens being determined, a first token of the pair being assigned to a first node in the knowledge graph, a second token of the pair being assigned to a second node in the knowledge graph, a weight for an edge between the first node and the second node being determined as a function of the classification, a graph or a spanning tree being determined as a function of the first node, of the second node and of the weight for the edge, and the knowledge graph being filled with a relation for the pair if the graph or the spanning tree includes the edge, and the knowledge graph otherwise not being filled with the relation. The weight represents a probability for an existence of an edge, which is determined directly from the classification.

The relation in the knowledge graph is preferably assigned a label, which is defined by the classification. As a result, the knowledge graph is determined with a non-factorized approach, in which both the label as well as the existence of the edge is determined in a module. As a result, it is not necessary, in addition to a module which determines the label for an existing edge, to train a further module, with which it is establishable whether or not the edge exists.

Various classifications may be determined for different pairs of tokens, the graph or the spanning tree being determined as a function of the classifications. The classifications define a graph including edges between all nodes, which are variously weighted. A maximum spanning tree, for example, is then calculated from this graph as a tree, which connects all nodes but has no cycles.

In one aspect of the present invention, a classification for a token is determined and the knowledge graph is filled with a label for the token as a function of the classification for the token. As a result, a label, for example, a part of speech, is assigned to the token itself.

In one aspect of the present invention, the knowledge graph is filled with a relation for the pair if the weight for the edge fulfills one condition, and the knowledge graph otherwise not being filled with the relation. In addition to relations that are inserted due to the spanning tree, relations for edges from a graph may also be inserted. The knowledge graph is thus expanded by relations from the graph.

In one aspect of the present invention, a training data point for a training is provided, which includes a set of tokens and at least one reference for a classification for at least one pair of tokens from the set of tokens, the reference for the classification for a first token of the pair defining a first node in a graph, for a second token of the pair defining a second node in the graph, and for the classification defining a weight for an edge between the first node and the second node, which is part of a spanning tree in the graph, a classification for the pair of tokens being determined from the set of tokens, and at least one parameter for the training being determined as a function of the classification of the edge and of the reference therefor. The classification of the edge corresponds to the label for the latter. In this way, a parser is trained in a tool for generating a knowledge graph, which is able to determine the label for edges for the knowledge graph.

The training data point may include a reference for a classification of one of the tokens from the set of tokens, a classification for the token being determined, at least one parameter for the training being determined as a function of the classification and of the reference therefor. In this way, a parser is trained in a tool for generating a knowledge graph, which is able to determine the label for nodes for the knowledge graph.

The training data point may include a reference for a classification for the at least one pair of tokens from the set of tokens, the reference for the classification for a first token of the pair defining a first node in a graph, for a second token of the pair defining a second node in the graph, and for the classification defining a weight for an edge between the first node and the second node, which is part of the graph, a classification for the at least one pair of tokens from the set of tokens being determined, and at least one parameter for the training being determined as a function of the classification for the edge of the graph and of the reference therefor. The classification of the edge corresponds to the label for the latter. As a result, a parser is provided in a tool for generating both a spanning tree as well as a graph for the knowledge graph.

In accordance with an example embodiment of the present invention, a device for filling the knowledge graph is designed to carry out the method.

### BRIEF DESCRIPTION OF THE DRAWINGS

Further advantageous embodiments result from the description and from the figures.

FIG. 1 shows a device for carrying out computer-implemented methods, in accordance with an example embodiment of the present invention.

FIG. 2 shows a first computer-implemented method for filling a knowledge graph, in accordance with an example embodiment of the present invention.

FIG. 3 shows a second computer-implemented method for filling a knowledge graph, in accordance with an example embodiment of the present invention.

FIG. 4 shows a third computer-implemented method for filling a knowledge graph, in accordance with an example embodiment of the present invention.

FIG. 5 shows a computer-implemented method for training a first parser, in accordance with an example embodiment of the present invention.

FIG. 6 shows a computer-implemented method for training a second parser, in accordance with an example embodiment of the present invention.

FIG. 7 shows a computer-implemented method for training a third parser, in accordance with an example embodiment of the present invention.

### DETAILED DESCRIPTION OF EXAMPLE EMBODIMENTS

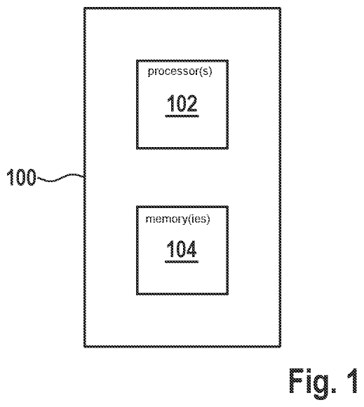

FIG. 1 schematically represents a device 100 for filling a knowledge graph. Device 100 is designed to carry out the method described below.

Device 100 includes at least one processor 102 and at least one memory 104. Computer-readable instructions may be stored in memory 104, upon execution of which by processor 102, steps of the method are able to proceed.

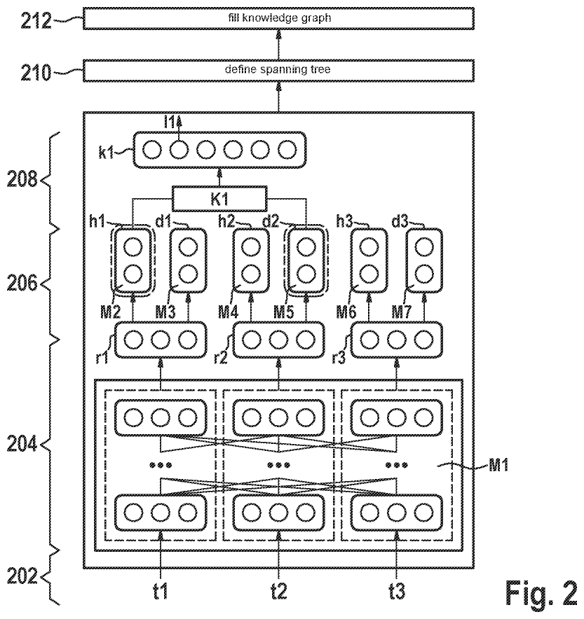

A first method for filling a knowledge graph is schematically represented in FIG. 2.

A set of tokens is provided in a step 202. In FIG. 2, one first token t1, one second token t2 and one third token t3 are represented by way of example. A plurality of tokens may be provided. For example, a sentence including i words is subdivided by a tokenizer into i tokens.

It may be provided to generate the tokens with stanza from the StanfordNLP system, which is described, for example, in Peng Qi, Timothy Dozat, Yuhao Zhang, and Christopher D. Manning. 2018. “Universal dependency parsing from scratch.” In Proceedings of the CoNLL 2018 Shared Task: Multilingual Parsing from Raw Text to Universal Dependencies, pages 160-170, Brussels, Belgium. Association for Computational Linguistics.

Pre-processed text, in particular, the tokens, may be specified. Step 202 is omitted in this case.

In a step 204, first token t1 is mapped with a model M1 onto a first embedding r1.

In step 204, second token t2 is mapped with model M1 onto a second embedding r2.

In step 204, third token t3 is mapped with model M1 onto a third embedding r3.

Model M1 in the example is a linguistic model based on a transformer, in particular, pre-trained, in particular, a transformer, for example, XLM-R, BERT or RoBERTa.

XLM-R is described, for example, in Alexis Conneau et al. 2019. “Unsupervised cross-lingual representation learning at scale.” arXiv preprint arXiv:1911.02116.

BERT is described, for example, in Jacob Devlin, Ming-Wei Chang, Kenton Lee, and Kristina Toutanova. 2019. “BERT: Pre-training of deep bidirectional transformers for language understanding.” In Proceedings of the 2019 Conference of the North American Chapter of the Association for Computational Linguistics: Human Language Technologies, Volume 1 (Long and Short Papers), pages 4171-4186, Minneapolis, Minn. Association for Computational Linguistics.

RoBERTa is described, for example, in Yinhan Liu, Myle Ott, Naman Goyal, Jingfei Du, Mandar Joshi, Danqi Chen, Omer Levy, Mike Lewis, Luke Zettlemoyer, and Veselin Stoyanov. 2019b. “Roberta: A robustly optimized bert pretraining approach.” arXiv preprint arXiv:1907.11692.

It may be provided that a plurality of embeddings is determined from the plurality of tokens.

Model M1 is, for example, an artificial neural network, which outputs a vector for each of the tokens. The vector, which model M1 outputs for a token, is its embedding.

In a step 206, first embedding r1 is mapped with a model M2 onto a representation h1 of a beginning of an edge. In step 206, the first embedding is mapped with a model M3 onto a representation d1 of an end of an edge.

In a step 206, second embedding r2 is mapped with a model M4 onto a representation h2 of a beginning of an edge. In step 206, second embedding r2 is mapped with a model M5 onto a representation d2 of an end of an edge.

In a step 206, third embedding r2 is mapped with a model M6 onto a representation h3 of a beginning of an edge. In step 206, third embedding r3 is mapped with a model M7 onto a representation d3 of an end of an edge.

For example, one embedding each, i.e., a vector rᵢ, is determined for tokens i of the sentence.

For example, each of models M2 through M7 is a part separate from the other parts of the neural network. Separate in this context means that the output of a layer or of a neuron of one part has no influence on one of the other parts during a forward propagation. Separate artificial neural networks may also be provided. The parts in the example which determine the representations for beginnings of edges, are implemented in the example by a single-layer feed-forward neural network, FNN^{h}, in particular, as a linear, fully connected layer. Representation hᵢ for the beginning of an edge is for a vector rᵢ, thus, for example

hᵢ=FNN^{h}(rᵢ)

The representation hᵢ is a vector that represents the meaning of token tᵢ when token tᵢ represents the beginning of a potential edge.

The parts in the example that determine the representations for end of edges are implemented in the example by a single-layer feed-forward neural network FNN^{d}, in particular, as a linear fully connected layer. Representation dᵢ for the end of an edge is for vector rᵢ, thus, for example,

dᵢ=FNN^{d}(rᵢ)

Representation dᵢ is a vector that represents the meaning of token tᵢ when token tᵢ represents the end of a potential edge.

For in particular ordered pairs of tokens tᵢ, tⱼ in the example, their representations hᵢ, dᵢ, hⱼ, dⱼ for the beginning and the end of a potential edge are determined in each case.

In a step 208, a classification k1 is determined for a pair of tokens from the set of tokens. In the example, a plurality of classifications is determined with a classifier K1 for a plurality of pairs of tokens. In one aspect, the potentially ordered pairs of tokens are determined from the set of tokens, in particular, from a sentence, and classification k1 is determined for each potentially ordered pair.

Classification k1 in the example includes probability values for labels for existing edges and a specific label for non-existing edges.

In the example, a first token of the pair defines a first node in a graph, a second token of the pair defines a second node in the graph. Classification k1 defines a weight for an edge between the first node and the second node. The weight is determined, for example, as a sum of the probability values in classification k1, which are not assigned to the label for non-existent edges.

In the example represented in FIG. 2, classification k1 for the edge is determined with classifier K1 as a function of representation h1 and representation d2. This edge, when it is used to fill the knowledge graph, leads from a node that represents first token t1 in the knowledge graph to a node that represents second token t2 in the knowledge graph.

In the example, classification k1 may define a property of the edge, for example, a label I1 for the edge. The property may indicate whether or not the edge exists.

For example, classifier K1 includes an artificial neural network, in particular, including a biaffine layer

Biaff(x₁,x₂)=x₁^{T}Ux₂+W(x₁⊕x₂)+b

which determines a vector of logits

s_{i,j}=Biaff(hᵢ,dᵢ),

which indicate values of an activation of the potential labels for the edge. In other words, each dimension of the vector corresponds to a label. x₁, x₂ in the example are vectors for a pair of tokens t₁, t₂. Learned parameters of the artificial neural network are identified with U, W and b. β represents a concatenation operation. Classifier K1 in the example includes a normalization layer, for example, a softmax layer, with which a probability P(y_{i,j}) is determined as a function of the values.

P(y_{i,j})=softmax(s_{i,j})

The label for an edge is identified with y_{i,j}, which begins at a token represented by representation hᵢ and ends at a token represented by representation dⱼ. A non-existence of an edge is indicated in the example by an artificial label. Various classifications are determined for labels that are defined by different pairs of tokens.

In the example, hᵢ, dⱼ are inputs of classifier K1. In the example, P(y_{i,j}) is an output of classifier K1.

In a step 210, a spanning tree in the graph is defined as a function of the weight for label y_{i,j}. In the example, a spanning tree is determined, which includes the nodes for the pair of tokens and defines an edge between these nodes in the knowledge graph identified with label y_{i,j}.

For example, the spanning tree algorithm is used. This algorithm obtains weights as input variables, which are assigned to potential edges. These weights are calculated in the example as a function of the classifications. Which of the potential edges are added to the spanning tree is decided by a global optimization. The minimum or the maximum spanning tree algorithm may be used, for example.

For example, a weight from classification k1 is determined for label y_{i,j}. In the example, the weight for label y_{i,j} is determined as a value of probability P(y_{i,j}).

To determine the spanning tree, the Chu-Liu/Edmonds MST algorithm, for example, is used, which is described in Y. J. Chu and T. H. Liu. 1965. “On the shortest arborescence of a directed graph.” Science Sinica, 14:1396-1400 and J. Edmonds. 1967. “Optimum branchings.” Journal of Research of the National Bureau of Standards, 71B:233-240.

The knowledge graph is filled in a step 212.

The knowledge graph is filled with nodes for the tokens from the set of tokens. The edges are determined as defined by the spanning tree.

In the example, a first token of the pair is assigned to a first node in the knowledge graph and a second token of the pair is assigned to a second node in the knowledge graph.

The knowledge graph is filled, for example, with a relation for the pair if the spanning tree includes the edge assigned to the pair. Otherwise, the knowledge graph is not filled with this relation.

The relation in the example is assigned a label in the knowledge graph, which is defined by the classification for the edge. In this way, it is not necessary to first determine an existence of the edge and then its label. Instead, one module is sufficient in order to determine the existence of the edge and the label.

In the example, the relations that are defined by the spanning tree are assigned their label as a function of their classification.

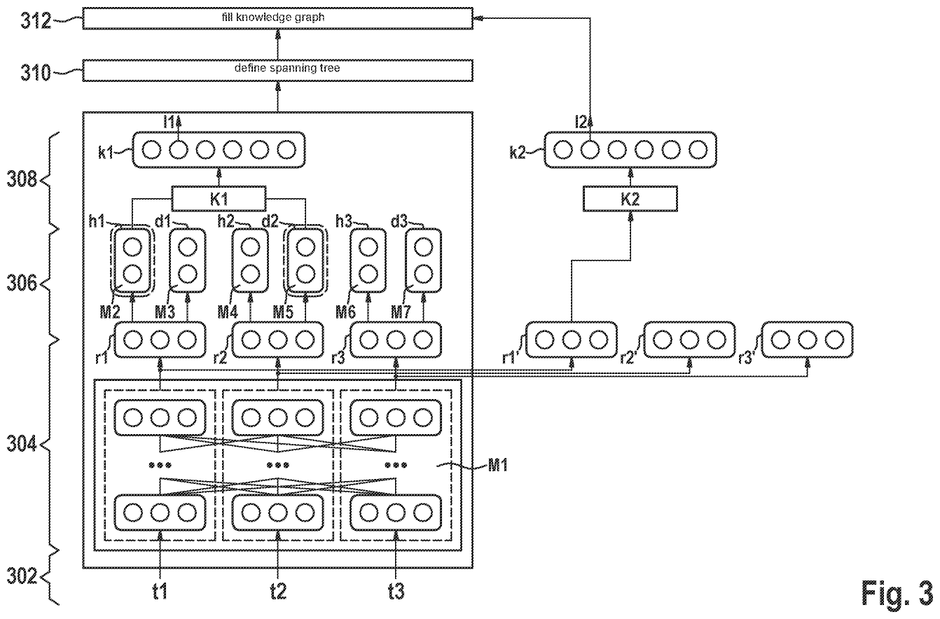

A second method for filling a knowledge graph is schematically represented in FIG. 3.

The procedure in a step 302 is the same as described for step 202. Step 302 is optional if tokens are already available.

The procedure in a step 304 is the same as described for step 204. In addition, at least one token from the set of tokens is mapped with first model M1 onto a further embedding.

In the example, first token t1 is mapped with a model M1 onto a further embedding r1′.

In the example, second token t2 is mapped with model M1 onto a fifth embedding r2′.

In the example, third token t3 is mapped with model M1 onto a sixth embedding r3′.

This means that model M1 may include more than one output for a token.

The procedure in a step 306 is the same as described for step 206.

The procedure in a step 308 is the same as described for step 208. In addition, a classification k2 is determined with a classifier K2 as a function of at least one of the embeddings also determined in step 304 for the token, for which this embedding has been determined. This is represented in the example for the fourth embedding. The fourth token in the example is assigned a further label I2, for example, a part of speech, by classification k2. One classifier each, which determines one classification each and one label each, may also be provided for the fifth embedding and/or for the sixth embedding. The labels for these embeddings may also be determined by a classification by classifier K2. This classifier then includes inputs for these embeddings.

In the example, it is provided to determine one classification k2 each for the tokens from the set of tokens.

For the tokens, one vector is determined per token and per output. For this purpose, a single-layer feed-forward neural network (FNN), is used, for example, which is implemented, in particular, as a fully connected layer. In one example, a vector v_{i,o} for a token tᵢ and an output o

v_{i,o}=FNN(r_{i,o})

is determined.

The r_{i,o} in the example are output-specific embeddings, which are generated in an implementation, for example, with the aid of a linear mixture of the internal layers of a transformer linguistic model. Output-specific in this context means that each output of the whole model has its own coefficients for this linear mixture.

The v_{i,o} in the example are score vectors, which are calculated with the aid of an FNN on the basis of r_{i,o}. They contain scores for the various possible labels of the respective classification task, for example, POS tags or morphological features. These may be converted into probabilities with the aid of a softmax layer.

In one aspect, one label each is assigned to each of the tokens from a plurality of possible labels for the tokens by a respective vector v_{i,o}. In this aspect, vector v_{i,o} represents classification k2. In the example, vector v_{i,o} includes logits, which represent one score each for the labels from the plurality of labels. In the example, token tᵢ is assigned label I2, for which vector v_{i,o} exhibits the highest score.

Output o may relate to a morph-feature output v_{i,morph} or to a part of speech, POS, tag output v_{i,pos}.

In this context, a label for a token tᵢ is identified with morph feature output, in particular, a feature character string. In the example, the feature character string is determined, which in a probability distribution P(y_{i,morph}) across multiple feature character strings is the most probable feature character string. This probability distribution P(y_{i,morph}) is determined, for example, for one of embeddings r_{i,morph} with the single-layer feed-forward neural network, FNN, and a softmax layer:

v_{i,morph}=FNN(r_{i,morph})

P(y_{i,morph})==softmax(v_{i,morph})

In this context, a label for a token tᵢ, in particular a tag, is identified with the POS tag output. In the example, a sequence of tags is determined for the token from the sentence. For token tᵢ, the tag is determined, which in a probability distribution P(y_{i,pos}) across multiple tags is the most probable tag. This probability distribution P(y_{i,pos}) is determined, for example, for one of embeddings r_{i,pos} with the single-layer feed-forward neural network, FNN, and a softmax layer:

v_{i,pos}=FNN(r_{i,pos})

P(y_{i,pos})=softmax(v_{i,pos})

Label I2 may be the feature character string and/or the tag for the respective token. In this aspect, probability distribution P(y_{i,pos}) represents classification k2.

In one aspect, probability distribution P(y_{i,pos}) is provided with the probability distributions of the other tokens in a conditional random field (CRF), layer.

The conditional random field in the example is a probabilistic model, which is designed, in particular, as a linear chain conditional random model.

The CRF in the example obtains a sequence of the probability distributions as input and outputs a sequence of tags, in particular, of equal length.

The CRF in the example is an artificial neural network, whose weights represent learned transition probabilities between tags. The set of tokens is preferably a sequence of tokens, which establishes an order for the probability distributions in the sequence of the probability distribution. The sequence of tokens is an order, in which the tokens, for example, words from the sentence, are situated one behind the other.

The CRF layer outputs the sequence of tags, in particular, for the entire sequence of tokens. In this aspect, the sequence of tags includes classification k2.

The sequence of tags is specified for the labels of the tokens from the sentence. Contrary to considering the positions of individual character strings, in this case, the transition probabilities between the tags is considered.

In one aspect, vector v_{i,pos} instead of probability distribution P(y_{i,pos}) may be provided with the other tokens in a conditional random field, CRF, layer with transition probabilities learned for vectors. In this way, the vectors are newly weighted. This CRF layer in this aspect outputs the sequence of tags, in particular, for the entire sequence of tokens.

Classifier K2 in the example is an artificial neural network, which includes the FNN layers. In one aspect, this artificial neural network includes the CRF layer.

The procedure in a step 310 is the same as described for step 210.

The procedure in a step 312 is the same as described for step 212. In addition, the knowledge graph is filled with the label for the token as a function of the classification for the token. In the example, at least one node in the knowledge graph, which represents a token, is assigned the label determined therefor in additional steps 304 and 308.

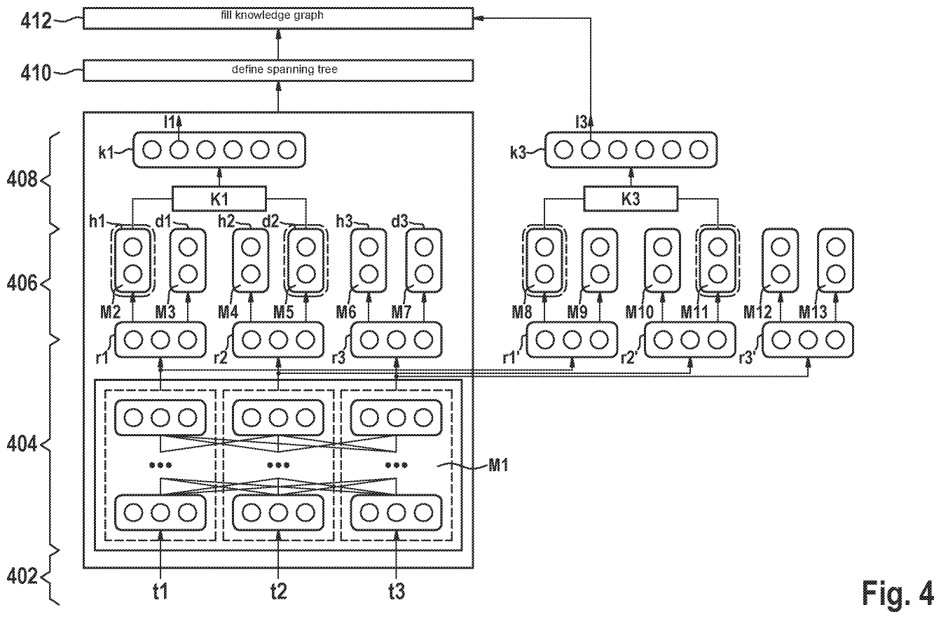

FIG. 4 schematically represents a third method for filling a knowledge graph.

The procedure in a step 402 is the same as described for step 202. Step 402 is optional if tokens are already available.

The procedure in a step 404 is the same as described for step 204.

The procedure in a step 406 is the same as described for step 206. In addition, the first embedding is mapped with a model M8 onto a representation h1′ of a beginning of an edge of the graph. In addition, first embedding r1 is mapped with a model M9 onto a representation d1′ of an end of an edge of the graph. In addition, second embedding r2 is mapped with a model M10 onto a representation h2′ of a beginning of an edge of the graph. In addition, second embedding r2 is mapped with a model M11 onto a representation d2′ of an end of an edge of the graph. In addition, third embedding r3 is mapped with a model M12 onto a representation h3′ of a beginning of an edge of the graph. In addition, third embedding r3 is mapped with a model M13 onto a representation d3′ of an end of an edge of the graph.

The procedure may be similar for a plurality of embeddings. The representation for the beginning of an edge is thus, for example,

h′ᵢ=FNN^{h}′(rᵢ)

for a vector rᵢ.

The representation for the end of an edge is thus, for example,

d′ᵢ=FNN^{d}′(rᵢ)

for vector rᵢ.

The procedure in a step 408 is the same as described for step 208. In addition, with a third classifier K3 as a function of at least one of the representations of the beginning and of the representations of the end of an edge, a classification k3 for this edge is determined.

Classification k3 in this example includes probability values for labels for existing edges and a specific label for non-existing edges.

In the example, a first token of the pair defines a first node in a graph, a second token of the pair defines a second node in the graph. Classification k3 defines a weight for an edge between the first node and the second node. The weight is determined, for example, as a sum of the probability values in classification k3, which are not assigned to the label for non-existent edges.

In the example, classification k3 is determined with a classifier K3 for the edge that connects token t1 with token t2 as a function of representation h1′ of the beginning and of representation d2′ of the end of the edge of the graph. It may be provided to determine a label I3 for this edge as a function of classification k3.

For example, classifier K3 includes an artificial neural network, in particular, determined with a biaffine layer

Biaff(x₁,x₂)=x₁^{T}Ux₂+W(x₁⊕x₂)+b

of logits

s′_{i,j}=Biaff(h′ᵢ,d′ⱼ,)

which indicate the values of an activation of the potential labels for the edge. x₁, x₂ are the vectors for pair of tokens t₁, t₂. Learned parameters are identified with U, W and b. ⊕ represents a concatenation operation. Classifier K3 in the example includes a normalization layer, for example, a softmax layer, with which a probability P′(y′_{i,j}) is determined as a function of the values.

P′(y′_{i,j})=softmax(s′_{i,j})

A label for an edge is identified with y′_{i,j}, which begins at a token represented by representation h′ᵢ and ends at a token represented by representation d′ⱼ. Various classifications are determined for labels that are defined by different pairs of tokens.

In the example, h′ᵢ, d′ⱼ are inputs of classifier K3. In the example, P′(y′_{i,j}) is an output of classifier K3.

The procedure in a step 410 is the same as described for step 210. In addition to the spanning tree, a graph is also determined, which includes the nodes for the set of tokens and defines edges between the nodes in the knowledge graph.

A relation is added to the knowledge graph if the classification for the edge fulfills one condition. Otherwise, the relation is not added to the knowledge graph. This condition is fulfilled in the example if the weight for the edge includes the edge as an existing edge. In the example, the weight is determined as a function of the classification. The weight is determined, for example, as the sum of the probabilities from the classification, which are not assigned to the label for non-existent edges.

In the example, a dependency graph is determined for the graph. The dependency graph in the example represents a representation of the syntactic relationships of the sentence from which the tokens originate. The graph in the example is determined as follows:

a. determination of a token as root node,

b. addition of all edges, for which the weight is greater than a threshold value. The threshold value is a parameter differing, in particular, from zero, which indicates the probability from where an edge is considered as non-existent.

c. as long as there is still one subgraph in the graph that is unreachable from the root node: selection of an edge, which connects the part, in which the root node is situated, and the not yet reachable subgraph. In the case of multiple potential edges the edge is selected in the example, which is assigned the highest weight compared to the other potential edge or the other potential edges.

A knowledge graph, which represents, in particular, syntactic relationships for the sentence as a graph, may be more expressive, since nodes may have more than one parent node. In contrast, a knowledge graph that represents syntactic relationships for the sentence as a spanning tree is algorithmically easier to process.

The procedure in a step 412 is the same as described for step 212. In addition, the knowledge graph is filled with a relation for the pair if the graph includes an edge between the nodes that represent the pair. Otherwise, the knowledge graph is not filled with a relation therefor.

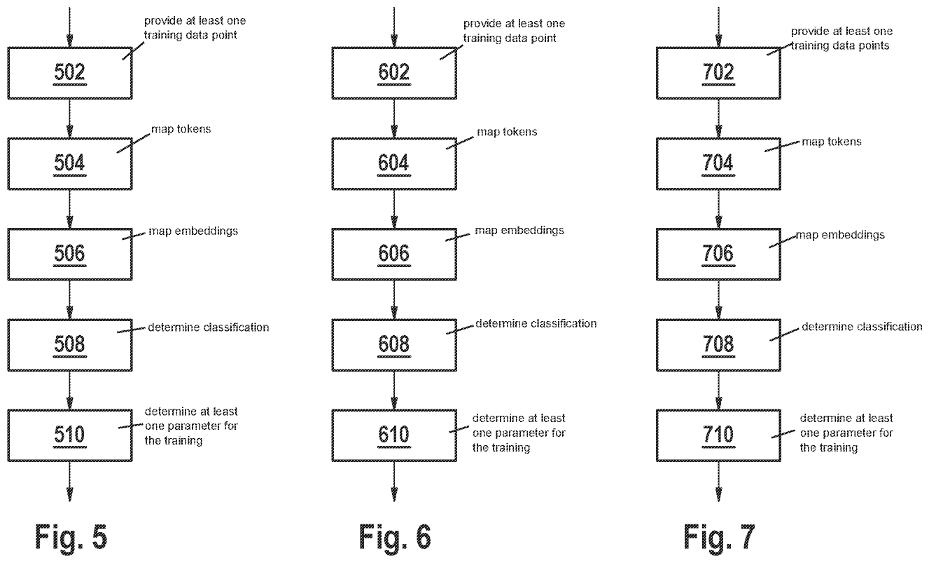

A method for training a first parser is described below with reference to FIG. 5.

The first parser includes model M1 and classifier K1. Model M1 in the example is the above-described neural network. The parameters of the artificial neural network are trained in the training.

The first parser includes in addition a number m/2 of models for the tokens from the plurality of tokens, with which in each case a token is mapped onto its representation of the beginning of an edge, and a number m/2 of models, with which in each case a token is mapped onto its representation of the end of an edge.

In the example, the m models are provided with M2, M3, M4, M5, M6 and M7.

These m models in the example are various parts of an artificial neural network, which are separate from one another. Each of models M2 through M7 in the example is designed as a part separate from the other parts of the artificial neural network. Separate in this context means that the output of a layer or of a neuron of a part has no influence on one of the other parts during a forward propagation. Separate artificial neural networks may also be provided. A part is implemented in the example by the above-described single-layer feed-forward neural network, FNN, in particular, as a linear, fully connected layer. The parameters of this artificial neural network are trained in the training.

Classifier K1 in the example is the above-described neural network, in particular, including the biaffine layer. The parameters of this artificial neural network are trained in the training. In the example, parameters U, W, and b are trained.

In the example, a plurality of training data points is provided in a step 502.

In step 502, at least one training data point is provided, which includes a set of tokens and at least one reference for a classification for at least one pair of tokens from the set of tokens. The reference for the classification in the example defines a first node in a graph for a first token of the pair. The reference for the classification in the example defines a second node in the graph for a second token of the pair. The reference for the classification in the example defines for the classification whether or not an edge, which is part of a spanning tree in the graph, exists between the first node and the second node. Edges not forming part of the spanning tree may also be used in the training. The reference in the example specifies a binary value, which indicates whether or not an edge exists. The training data points in the example each represent two nodes and one label. The reference for probability P(y′_{i,j}) for an actual label in the example is 100%, i.e., one. The reference for the other labels in the example is zero. The training task in the example is to predict whether or not a potential edge in the spanning tree exists. In the example, a probability distribution is output, which represents edge weights.

The training data point in the example includes a sentence, which includes a plurality of tokens. A training data point also includes a reference for a plurality of classifications k1, onto which in each case pairs of tokens from the sentence are mapped. In the example, the training data point for a pair of tokens tᵢ, tⱼ includes as a reference probability P(y_{i,j}). The training data point includes, for example, 3-dimensional tensor tᵢ, tⱼ, P(y_{i,j})). The reference for the plurality of classifications k1 in this example represents the spanning tree. Probability P(y_{i,j}) for label y_{i,j} of the potential edge represents, for example, an existing edge of the spanning tree. Probability P(y_{i,j}) for label y_{i,j} of the potential edge is, for example, a distribution of values.

In a step 504, tokens are mapped with model M1 onto their embeddings.

In a step 506, the embeddings are mapped on the one hand onto their representation of a beginning of an edge and on the other hand onto their representation of an end of an edge.

In a step 508, a classification for the pair of tokens is determined from the set of tokens. In the example, respective classification k1 for the potential edges is determined with respective classifier K1.

Steps 504 through 508 represent a forward propagation, which is carried out in the example for the plurality of the training data points.

In a step 510, at least one parameter for the training, i.e., in particular a parameter or multiple parameters of one of the models and/or of classifier K1, is determined as a function of the classification of the edge and of the reference therefor.

In step 510, a training with a back propagation including a loss is carried out in the example as a function of a plurality of classifications k1, which have been determined for the plurality of training data points in the forward propagation. The loss is defined as a function of a plurality of deviations. For example, a deviation between the plurality of classifications k1, which have been determined for a training data point in the forward propagation, from the reference therefor from this training data point, is used in order to determine the plurality of the deviations for the training data points.

The parameters of the models, with which the representations of the beginnings of the edges are determined, are determined in the example separately from the parameters of the models, with which the representations of the ends of the edges are determined.

The parameters of model M1 are determined as a function of the reference for the plurality of classifications k1,

The parser trained in this manner contains trained parameters, with which the method described with reference to FIG. 2 is implementable. For example, step 202 is implemented after step 510.

A method for training a second parser is described below with reference to FIG. 6.

The second parser in the example includes the first parser. Model M1 of the second parser, in contrast to model M1 of the first parser, includes additional outputs for additional embeddings. Model M1 of the second parser in the example includes additional outputs for the embeddings for the same tokens.

The second parser also includes a plurality of classifiers K2. In the example, one classifier K2 each, which is designed to determine classification k2 for this embedding, is assigned to the additional outputs for the embeddings. The second parser may also include a classifier K2 for the embeddings, which determines a classification k2 for the embeddings.

Model M1 in the example is the above-described artificial neural network and includes the additional outputs for the additional embeddings. The parameters of the artificial neural network are trained in the training.

The second parser also includes the number m/2 of models, with which one token each is mapped onto its representation of the beginning of an edge, and the number m/2 of models, with which one token each is mapped onto its representation of the end of an edge. In the example, the parameters of the above-described artificial neural network for these models are trained in the training.

Classifier K1 in the example is the above-described artificial neural network, in particular, including the biaffine layer. The parameters of this artificial neural network are trained in the training. In the example, parameters U, W, and b are trained.

Classifier K2 in the example is the above described artificial neural network. The parameters of this artificial neural network are trained in the training.

A plurality of training data points is provided in a step 602.

In step 602, at least one training data point is provided, which includes a set of tokens and at least one reference for a classification of at least one edge between two nodes of a spanning tree. The training data point also includes a reference for a classification of at least one of the tokens from the set of tokens.

The training data point in the example is defined the same as for the training of the first parser. The training data point also includes one reference each for the plurality of classifications k2 for the plurality of tokens. If only one classifier K2 for the tokens is provided, a reference for classification k2 may also be provided.

The procedure in a step 604 is the same as described for step 504. In addition, one token from the set of tokens is mapped with model M1 onto a further embedding. In the example, the tokens from the set of tokens are mapped with model M1 onto further embeddings.

The procedure in a step 606 is the same as described for step 506.

The procedure in a step 608 is the same as described for step 508. In addition, a classification is determined for the token.

Classification k2 for this token is determined with classifier K2 as a function of the further embedding. In the example, a respective classification k2 is determined for the additional embeddings.

Steps 604 through 608 represent a forward propagation, which is carried out in the example for the plurality of the training data points.

In a step 610, at least one parameter for the training, i.e., in particular, one parameter or multiple parameters of one of the models and/or of the classifiers is determined. In the example, a training with a back propagation including a loss is carried out as a function of a plurality of classifications k1 and of a plurality of classifications k2, which have been determined for the plurality of the training data points in the forward propagation.

The loss is defined as a function of a plurality of deviations. For example, a deviation between the plurality of classifications k1, which have been determined for a training data point in the forward propagation, from the reference therefor from this training data point, is used in order to determine for the training data points at least a portion of the plurality of the deviations. For example, a deviation between the plurality of classifications k2, which have been determined for a training data point in the forward propagation, from the reference therefor from this training data point, is used in order to determine for the training data points at least a portion of the plurality of the deviations.

The parameters of the models, with which the representations of the beginnings of the edges are determined, are determined in the example separately from the parameters of the models, with which the representations of the ends of the edges are determined.

The parameters of classifier K1 and of classifier K2 are determined in the example separately from one another.

The parameters of model M1 are determined as a function of the reference for the plurality of classifications k1 and of the reference for the plurality of classifications k2.

At least one parameter for one of the models, first classifier K1 and/or for second classifier K2, is determined as a function of classification k1 and/or of classification k2 and of the reference therefor.

The parser trained in this manner contains trained parameters, with which the method described with reference to FIG. 3 is implementable. For example, step 302 is implemented after step 610.

A method for training a third parser is described below with reference to FIG. 7.

The third parser includes model M1, classifier K1 and classifier K3. Model M1 in the example is the above-described artificial neural network. The parameters of the artificial neural network are trained in the training.

The third parser also includes for the tokens from the plurality of tokens the number m/2 of models, with which one token each is mapped onto its representation of the beginning of an edge and the number m/2 of models, with which one token each is mapped onto its representation of the end of an edge.

In the example, the above-described m models M8, M9, M10, M11, M12 and M13 are provided.

The third parser also includes for the tokens from the plurality of tokens a number m/2 of models, with which one token each is mapped onto its representation of a beginning of an edge of a graph and a number m/2 of models, with which one token each is mapped onto its representation of an end of an edge of a graph.

These m models in the example are various parts of an artificial neural network, which are separate from one another. Each of models M8 through M13 in the example is designed as a part separate from the other parts of the artificial neural network. Separate in this context means that the output of a layer or of a neuron of one part has no influence on one of the other parts during a forward propagation. Separate artificial neural networks may also be provided. One part in the example is implemented by the single-layer feed-forward neural network, FNN, in particular, as a linear fully connected layer. The parameters of this artificial neural network are trained in the training.

Classifier K1 in the example is the above-described artificial neural network, in particular, including the biaffine layer. The parameters of this artificial neural network are trained in the training. In the example, parameters U, W, and b are trained. Classifier K3 in the example is the above-described artificial neural network, in particular, including a biaffine layer. The parameters of this artificial neural network are trained in the training.

A plurality of training data points are provided in a step 702.

In step 702, at least one training data point is provided, which includes a set of tokens and at least one reference for a classification of at least one edge between two nodes of a spanning tree.

The at least one training data point in the example is defined as described for the training of the first parser in step 502.

In addition, the reference for the classification for a first token of at least one pair defines a first node in a graph. In addition, the reference for the classification for a second token of the at least one pair defines a second node in the graph. In addition, the reference for the classification defines whether or not an edge exists between the first node and the second node, which is part of an, in particular, directed graph.

Edges not belonging to, in particular, the directed graph may also be used in the training. One such edge in the example is assigned a weight, which characterizes this edge as non-existent in the, in particular, directed graph.

In the example, the training data point also includes references for a plurality of classifications k3, onto which in each case pairs of tokens from the sentence are mapped. In the example, the training data point for one pair of tokens tᵢ, tⱼ includes as a further reference probability P(y′_{i,j}). The training data points in the example each represent two nodes and one label. The reference for probability P(y′_{i,j}) for an actual label is 100%, i.e., one. The reference for the other labels in the example is zero. The additional training task in the example is to predict whether or not a potential edge exists in the directed graph. In the example, a probability distribution is output, which represents edge weights. The classification task for which training takes place is binary in the example. The reference in the example includes unweighted edges. A loss is computed for example via a cross entropy between a probability distribution predicted in the training and the reference therefor. The training data point includes, for example, a 3-dimensional tensor tᵢ, tⱼ, P′(y′_{i,j})). The plurality of classifications k3 in this example represents the graph. Probability P(y′_{i,j}) for label y′_{i,j} of the potential edge represents, for example, an existing edge of the graph. Probability P(y′_{i,j}) for label y′_{i,j} of the potential edge is, for example, a distribution of values.

In a step 704, tokens are mapped with model M1 onto their embeddings.

In a step 706, the embeddings are mapped on the one hand onto their representation of a beginning of an edge of the spanning tree and on the other hand onto their representation of an end of an edge of the spanning tree.

In addition, at least one of the embeddings is mapped onto a representation of a beginning of an edge of the graph. In addition, at least one of the embeddings is mapped onto a representation of an end of the edge of the graph.

In a step 708, a classification for the at least one pair of tokens is determined from the set of tokens. In the example, respective classification k1 for the potential edges is determined with respective classifier K1.

In step 708, as a function of the representation of the beginning and of the representation of the end of at least one edge of the graph, classification k3 for this edge of the graph is also determined with classifier K3.

Steps 704 through 708 represent a forward propagation, which is carried out in the example for the plurality of the training data points.

In a step 710, at least one parameter for the training, i.e., in particular, one parameter or multiple parameters of one of the models and/or of the classifiers, is determined. In the example, a training with a back propagation including a loss is carried out as a function of a plurality of classifications k1 and of a plurality of classifications k3, which have been determined for the plurality of the training data points in the forward propagation.

The loss is defined as a function of a plurality of deviations. For example, a deviation between the plurality of classifications k1, which have been determined for a training data point in the forward propagation, from the reference therefor from this training data point is used in order to determine the plurality of the deviations for the training data points. For example, a deviation between the plurality of classifications k3, which have been determined for a training data point in the forward propagation, from the reference therefor from this training data point is used in order to determine the plurality of the deviations for the training data points.

The parameters of the models, with which the representations of the beginnings of the edges are determined, are determined in the example separately from the parameters of the models, with which the representations of the ends of the edges are determined.

The parameters of model M1 are determined as a function of the reference for the plurality of classifications k1 and of the reference for classification k3.

At least one parameter for one of the models is determined as a function of classification k3 for the edge of the graph and of the reference therefor.

The parser trained in this manner contains parameters, with which the method described with reference to FIG. 4 is implementable. For example, step 402 is implemented after step 710.

A fourth parser includes model M1 and classifier K3. These are trained with training data points, which specify the classifications k3 for a representation of the tokens of a sentence as a graph. It may be provided to form the knowledge graph for the sentence by determining tokens from the words of the sentence and, for the tokens with the fourth parser trained in this manner, classification k3 and as for these described entries for the knowledge graph.

A fifth parser includes model M1, classifier K2 and classifier K3. These are trained with training data points, which specify classifications k2, k3 for the tokens of a sentence. It may be provided to form the knowledge graph for the sentence by determining tokens from the words of the sentence and, for the tokens including the fifth parser trained in this manner, classifications k2, k3 and as for these described entries for the knowledge graph.

A sixth parser includes model M1, classifier K1, classifier K2 and classifier K3. These are trained with training data points, which specify classifications k1, k2, k3 for the tokens of a sentence. It may be provided to form the knowledge graph for the sentence by determining tokens from the words of the sentence and, for the tokens including the sixth parser trained in this manner, classifications k1, k2, k3 and as for these described entries for the knowledge graph.

1-10. (canceled)

11. A computer-implemented method for filling a knowledge graph, the method comprising the following steps:
filling the knowledge graph with nodes for tokens from a set of tokens, by:
determining a classification for a pair of tokens from the set of tokens, a first token of the pair of tokens being assigned to a first node in the knowledge graph, a second token of the pair of tokens being assigned to a second node in the knowledge graph;
determining a weight for an edge between the first node and the second node as a function of the classification for the pair of tokens;
determining a graph or a spanning tree as a function of the first node, of the second node and of the weight for the edge; and
filling the knowledge graph with a relation for the pair of tokens when the graph or the spanning tree includes the edge, and the knowledge graph otherwise not being filled with the relation.

12. The method as recited in claim 11, wherein the relation in the knowledge graph is assigned a label, which is defined by the classification for the pair of tokens.

13. The method as recited in claim 11, wherein various classifications are determined for different pairs of tokens, the graph or the spanning tree being determined as a function of the classifications.

14. The method as recited in claim 11, wherein a classification for a token from the set of tokens is determined, and the knowledge graph is filled with a label for the token as a function of the classification for the token.

15. The method as recited in claim 12, wherein the knowledge graph is filled with a relation for the pair of tokens when the weight for the edge fulfills a condition, and the knowledge graph otherwise not being filled with the relation.

16. A computer-implemented method for training a model for mapping tokens onto classifications, the method comprising the following steps:
providing a training data point, which includes a set of tokens and at least one reference for a classification for at least one pair of tokens from the set of tokens, the reference for the classification for a first token of the pair of tokens defining a first node in a graph, for a second token of the pair defining a second node in the graph, and for the classification defining whether or not an edge exists between the first node and the second node, which is part of a spanning tree in the graph;
determining a classification for the pair of tokens from the set of tokens; and
determining at least one parameter for the training as a function of the classification of the edge and of the reference for the edge.

17. The method as recited in claim 16, wherein the training data point includes a reference for a classification of a token from the set of tokens, a classification for the token being determined, at least one parameter for the training being determined as a function of the classification of the token and of the reference for the classification of the token.

18. The method as recited in claim 16, wherein the training data point includes a reference for the classification for the at least one pair of tokens from the set of tokens, the reference for the classification for the first token of the pair defining the first node in the graph, for the second token of the pair defining the second node in the graph, and defining for the classification whether or not an edge exists between the first node and the second node, which is part of the graph, the classification for the at least one pair of tokens from the set of tokens being determined, and a parameter for the training being determined as a function of the classification for the edge of the graph and of the reference for the classification for the edge of the graph.

19. A device for filling a knowledge graph, the device configured to fill the knowledge graph with nodes for tokens from a set of tokens, the device configured to:
determine a classification for a pair of tokens from the set of tokens, a first token of the pair of tokens being assigned to a first node in the knowledge graph, a second token of the pair of tokens being assigned to a second node in the knowledge graph;
determine a weight for an edge between the first node and the second node as a function of the classification for the pair of tokens;
determine a graph or a spanning tree as a function of the first node, of the second node and of the weight for the edge; and
fill the knowledge graph with a relation for the pair of tokens when the graph or the spanning tree includes the edge, and the knowledge graph otherwise not being filled with the relation.

20. A non-transitory computer-readable storage medium on which is stored a computer program including computer-readable instructions for a knowledge graph, the computer-readable instructions, when executed by a computer, causing the computer to perform the following steps:
filling the knowledge graph with nodes for tokens from a set of tokens, by:
determining a classification for a pair of tokens from the set of tokens, a first token of the pair of tokens being assigned to a first node in the knowledge graph, a second token of the pair of tokens being assigned to a second node in the knowledge graph,
determining a weight for an edge between the first node and the second node as a function of the classification for the pair of tokens,
determining a graph or a spanning tree as a function of the first node, of the second node and of the weight for the edge, and
filling the knowledge graph with a relation for the pair of tokens when the graph or the spanning tree includes the edge, and the knowledge graph otherwise not being filled with the relation.
